(19) United States
(12) Patent Application Publication
(10) Pub. No.: US 2004/0098666 A1
(43) Pub. Date: May 20, 2004

(54) Method for submitting securities and exchange commission filings utilizing the EDGAR system

(75) Inventor: Ron L. Smith II, Seattle, WA (US)

Correspondence Address: Robert K. Tendler, 65 Atlantic Avenue, Boston, MA, 02110, US

(73) Assignee: E.P. Executive Press, Inc.

(21) Appl. No.: 10/298,503

(22) Filed: Nov. 18, 2002

(51) Int. Cl. G06F 15/00

(52) U.S. Cl. 715/501.1; 715/505

(57) ABSTRACT

A method is provided for overcoming the problems associated with the arcane EDGAR software used by the Securities and Exchange Commission in the completion and filing of SEC forms. Upon login, the correct SEC form is presented to the user with the appropriate template, which when completed is in HTML, the language used by EDGAR. Once the form is completed, the system bypasses all but one link in the Securities and Exchange Commission website and transmits the completed form directly to the SEC's transmittal page, thus eliminating the necessity for viewing or interpreting the SEC website. Form completion, re-formatting and electronic filing with the Securities and Exchange Commission is accomplished by having a software program function as a web browser which goes to only one location, namely the place on the SEC website where file uploads occur.

### FIELD OF INVENTION

This invention relates to the electronic filing of forms in the Securities and Exchange Commission, and more particularly to a system that uses a specialized web browser to by-pass a large number of links in the EDGAR system and automatically file forms in the appropriate format.

### BACKGROUND OF THE INVENTION

It has been a requirement of the Securities and Exchange Commission that stock transfers and other contracts relating to the purchase, sale, transfer or encumbrance of stocks by directors, officers and 10% stockholders of public companies be reported to the Securities and Exchange Commission. Heretofore, some types of transactions, such as gifts, stock option grants, and most other forms of executive compensation needed to be reported only once a year, on Form 5. Most other transactions, primarily purchases and sales of stock in the open market, had to be reported within ten days after the end of the month in which the transaction occurred, on Form 4. Moreover, a Form 4 or Form 5 could include all transactions by the filer during the month or year covered by the report, which allowed filers to group together and report on a single form multiple transactions that occurred over an extended period of time.

However, the U.S. Congress has passed a law that requires officers, directors and 10% stockholders to report almost all transactions on Form 4, and to file the Form 4 with the Securities and Exchange Commission within two business days after the transaction. This places a severe requirement on individuals who are usually neither technically sophisticated nor are quite sure what is to be reported. While current law allows the form to be filed in paper format or electronically, at the filer's election, it will in many cases be impractical for the filer to prepare the form in time to send it via overnight mail for arrival at the Securities and Exchange Commission by the due date given the two-day time limit. As a practical matter, therefore, the reports often will have to be filed electronically.

Electronic filing of Forms 4 and 5 will become mandatory within one year. Electronic filings made now, or later when electronic filing becomes mandatory, must be submitted to the Securities and Exchange Commission through what is known as the EDGAR system, which stands for Electronic Data Gathering, Analysis and Retrieval. The EDGAR system, however, suffers from major problems in its use and implementation.

It will be appreciated that the EDGAR system developed in 1983 is an arcane system. It uses its own language and its own format which requires much training and understanding in order to be able to use the system. It was invented much before Microsoft Word was introduced, and is thus incompatible with modern computers or word processing systems. Most of those individuals now charged with the responsibility of reporting within two-days usually do not have the skills to create an ASCII or HTML document. While the Securities and Exchange Commission does provide what the Form should look like, the Commission does not provide the Form itself in electronic form.

As a result individuals must prepare and file Form 4 electronically, and this is a daunting task.

For instance, in order to access the EDGAR system, one must first find the sample forms that are hidden and buried in the Securities and Exchange Commission website. Moreover these forms are not easily accessed. Even when one tries to search through a search engine provided by the EDGAR system, unless the exact form number is provided, nothing will be reported back to the user. When one successfully enters a particular form such as “Form 4”, there are at least seven different choices that come up.

Then, once having downloaded the sample form, it is necessary to access instructions as to what information the form is supposed to contain. Note that the instructions provided with the form do not indicate how to file the form electronically.

If one seeks to file the form electronically, one has to apply for a “CIK” or code to be able to log into the EDGAR system and download the EDGAR software in order to do the electronic filing. This can takes as long as two days.

One then has to access the filing and forms link on the Securities and Exchange Commission web page, which gives information on the EDGAR files. One then has to download the filing instructions manually, with the manual including ten chapters and fourteen appendices, over 350 pages. One must then review the manual to ascertain how to enter information into the EDGAR format.

One then has to install the EDGAR software on one's own computer and install the necessary supporting software, such as the Java Virtual Machine.

One then must take the sample Form 4 and fill it out, usually by copying the form to a Microsoft Word document. However, when one then attempts to fill in the Form 4, Microsoft Word can create characters and formatting which are illegal in the EDGAR system.

The fact that the EDGAR system will not accept standard word documents is not immediately apparent to the user and it is only after many steps later when one attempts to have the filing accepted by the Securities and Exchange Commission that one is apprised of the fact that there is a problem. Moreover, the error messages are relatively obscure so that one does not necessarily know how to correct one's filing even when the error messages are presented.

Even when using the EDGAR software to prepare the filing, which is akin to placing the already generated submission in an envelope and telling where to file it, one is still perplexed because one has to figure which template out of eight one is supposed to use. After one has selected a template, one tells the EDGAR system to check the file format. When error messages are returned, the error messages are cryptic. So, at this point, it is unclear as to whether or not the filing will be successful.

If one finally obtains an indication that the format is correct, one then logs onto the EDGAR system's website and clicks through seven links in order to be able to successfully file the Form 4 submission.

The first link which must be selected is the transmit link, which is one of twelve or more links presented. Finding the transmit link thus presents a problem. Secondly, one must select between “transmit test” or “transmit live” information which is a selection made out of four different links, again, confusing. After one has selected whether or not to send a test or live transmission, one is instructed to browse to find the particular file that the EDGAR system has created. This is selected from one of two links which is either “transmit” or “browse”, which opens up a whole list of files from which one is to select which one is the EDGAR-created file. This is also not easy to do; but, if one can ascertain which file is to be filed, one then selects the “transmit” button, which uploads the file to the Securities and Exchange Commission.

If the user gave the Securities and Exchange Commission an e-mail reply address, the Securities and Exchange Commission will indicate if one's Form 4 has been properly filed.

What will be appreciated is that the EDGAR system is an exceedingly unwieldy system which taxes even the most sophisticated users to be able to file forms electronically. In the past, so complicated was the electronic filing that most of the companies using the EDGAR system did so by hiring specialized printing companies that would be able satisfy the formatting requirements of the EDGAR system. Alternatively, all of the filings were in hard copy form mailed or sent via overnight mail to the Securities and Exchange Commission.

However, with the new two-day requirement for Form 4, the EDGAR system is incapable of being understood and complied with in this two-day limit. Moreover, transactions which could have been reported once a year or could be grouped as a whole and filed one month after the transaction, now have to be filed within the two days. More importantly, each Form 4 transaction must be individually filed. With such a requirement, not only is the time limit short, but also the number of reportable transactions is expected to increase dramatically. Thus, in sheer volume, the EDGAR system is incapable of providing the reporting vehicle that is required by law.

### SUMMARY OF THE INVENTION

In order to permit prompt filings by untrained individuals, in the subject invention a specialized web browser is used by the individual making the filing. This specialized web browser automatically formats the inputted information into a format acceptable to EDGAR. After the form is filled out on the browser it is transmitted directly to the Securities and Exchange Commission website transmittal page, by-passing all intermediate links. Since the format is correct and it is sent to the right place, compliance is assured. Moreover, the user is instantly notified of success via an Accession Number transmitted back to the user by e-mail.

More particularly, a method is provided for overcoming the problems associated with using the arcane EDGAR software used by the Securities and Exchange Commission in the completion and filing of Securities and Exchange Commission forms. In one embodiment, Form 4 completion, re-formatting and electronic filing with the Securities and Exchange Commission is accomplished by having a user-controlled software program function as a web browser but which only goes to one location, namely the place, URL, where on the Securities and Exchange Commission website file uploads happen. In operation, the subject system takes the user ID and password and opens an HTTP connection to the Securities and Exchange Commission's login page on their website. The user ID and password are then submitted, and if accepted, EDGAR returns a Session ID used to identify the user to the Securities and Exchange Commission. Next, the subject system goes to the correct page for uploading the file. The file to be transmitted is then transformed into the proper format for HTTP file uploads and is sent directly to the Securities and Exchange Commission's transmittal page. If successful an Accession number is transmitted back to the user. As a result the user does not see the confusing SEC website or any pages so that he uses only an easy-to-use special purpose web browser for the Securities and Exchange Commission filing.

The subject invention facilitates the filing by automatically navigating through EDGAR links so that a form is filed with the Securities and Exchange Commission at the correct place and in the proper format, thus eliminating endless delays in re-formatting and presenting information, only to be rejected because all of the formatting rules are not obeyed and all of the steps have not been complied with. The filing steps are compressed by having the subject system go directly to the Securities and Exchange Commission's transmittal page URL, bypassing the large number of links originally presented on the Securities and Exchange Commission website by the EDGAR system.

Thus, for form and filing, after the user password has been entered, an auto-login process logs in directly to the Securities and Exchange Commission website and automatically goes through the links and pages. The Form 4 file is put into the correct format, up-loaded and an Accession Number is captured which is transmitted back to the user to indicate that the Form has been successfully submitted. In order to accomplish the automatic login and filing, the appropriate URL location is obtained from the EDGAR web server as to where the final destination of the Form is to be. The subject system therefore permits compliance with the Form 4 two-day filing requirement which is on individuals and not companies, thus to provide non-technical people with the ability to properly report purchase, sale, transfer, gifts, stock grants, option exercises or loans tied to stock in a particular company.

In summary, a method is provided for overcoming the problems associated with the arcane EDGAR software used by the Securities and Exchange Commission in the completion and filing of SEC forms. Upon login, the correct SEC form is presented to the user with the appropriate template, which when completed is in HTML, the language used by EDGAR. Once the form is completed, the system bypasses all but one link in the Securities and Exchange Commission website and transmits the completed form directly to the SEC's transmittal page, thus eliminating the necessity for viewing or interpreting the SEC website. Form completion, re-formatting and electronic filing with the Securities and Exchange Commission is accomplished by having a software program function as a web browser which goes to only one location, namely the place on the SEC website where file uploads occur. In one embodiment, the subject system takes the filer's user ID and password and opens an HTTP connection to the login page on the Securities and Exchange Commission's website. The user ID and password are then submitted, and if accepted, EDGAR returns a Session ID used to identify the user to the Securities and Exchange Commission. Next, the subject system automatically goes to the correct page for uploading the file. The file to be transmitted is already in the proper format for HTTP file uploads and is sent directly to the Securities and Exchange Commission's transmittal page. If successful an Accession number is transmitted back to the user. As a result the user does not see the confusing SEC website or any of its pages, but instead sees only the form produced by the subject system, and files the form through an easy-to-use special purpose web browser.

### BRIEF DESCRIPTION OF THE DRAWINGS

These and other features of the Subject Invention will be better understood in connection with the Detailed Description in conjunction with the Drawings, of which:

FIG. 1 is a diagrammatic illustration of the subject system in which an individual is seeking to complete and file a report with the SEC in which a specialized web browser provided with the appropriate template is used to format the submission which is then transmitted over the internet directly to the transmittal page of the SEC's website;

FIG. 2 is a diagrammatic representation of a screen shot of a template for Form 4 in which appropriate fields are to be filled in;

FIG. 3 is a diagrammatic illustration of a screen shot of an EDGAR information screen in which information about the submitting entity is entered and transmitted to the SEC;

FIG. 4 is a diagrammatic illustration of a screen shot of the subject EDGAR Filing Wizard indicating whether the filing is considered to be a Test Filing or a Live Filing;

FIG. 5 is a diagrammatic illustration of a screen shot indicating the entry of an individuals' CIK and PASSWORD; and,

FIG. 6 is a diagrammatic illustration of a screen shot indicating successful submission to the SEC, along with an Accession Number.

### DETAILED DESCRIPTION

Prior to describing the simplified Securities and Exchange Commission form submission system of the subject invention, Form 4 and Instructions from the SEC are presented:

FORM 4

STATEMENT OF CHANGES OF BENEFICIAL OWNERSHIP OF SECURITIES

The Commission is authorized to solicit the information required by this Form pursuant to Sections 16(a) and 23(a) of the Securities Exchange Act of 1934, Sections 17(a) and 20(a) of the Public Utility Holding Company Act of 1935, and Sections 30(f) and 38 of the Investment Company Act of 1940, and the rules and regulations thereunder.

Disclosure of information specified on this Form is mandatory, except for disclosure of the I.R.S. identification number of the reporting person if such person is an entity, which is voluntary. If such numbers are furnished, they will assist the Commission in distinguishing reporting persons with similar names and will facilitate the prompt processing of the Form. The information will be used for the primary purpose of disclosing the transactions and holdings of directors, officers, and beneficial owners of registered companies. Information disclosed will be a matter of public record and available for inspection by members of the public. The Commission can use it in investigations or litigation involving the federal securities laws or other civil, criminal, or regulatory statutes or provisions, as well as for referral to other governmental authorities and self-regulatory organizations. Failure to disclose required information may result in civil or criminal action against persons involved for violations of the Federal securities laws and rules.

Potential persons who are to respond to the collection of information contained in this form are not required to respond unless the form displays a currently valid OMB control number.

General Instructions

1. When Form Must be Filed

(a) This Form must be filed on or before the tenth day after the end of the month in which a change in beneficial ownership has occurred (the term “beneficial owner” is defined in Rule 16a-1(a)(2) and discussed in Instruction 4). This Form and any amendment is deemed filed with the Commission or the Exchange on the date it is received by the Commission or Exchange, respectively. See, however, Rule 16a-3(h) regarding delivery to a third party business that guarantees delivery of the filing no later than the specified due date.

(b) A reporting person no longer subject to Section 16 of the Securities Exchange Act of 1934 (“Exchange Act”) must check the exit box appearing on this Form. However, Form 4 and 5 obligations may continue to be applicable. See Rule 16a-3(f); see also Rule 16a-2(b) (transactions after termination of insider status). Form 5 transactions to date may be included on this Form and subsequent Form 5 transactions may be reported on a later Form 4 or Form 5, provided all transactions are reported by the required date.

(c) A separate Form shall be filed to reflect beneficial ownership of securities of each issuer, except that a single statement shall be filed with respect to the securities of a registered public utility holding company and all of its subsidiary companies.

(d) If a reporting person is not an officer, director, or ten percent holder, the person should check “other” in Item 6 (Relationship of Reporting Person to Issuer) and describe the reason for reporting status in the space provided.

2. Where Form Must be Filed

(a) File three copies of this Form or any amendment, at least one of which is manually signed, with the Securities and Exchange Commission, 450 5th Street, N.W., Washington, D.C. 20549. (Note: Acknowledgment of receipt by the Commission may be obtained by enclosing a self-addressed stamped postcard identifying the Form or amendment filed.) Alternatively, this Form is permitted to be submitted to the Commission in electronic format at the option of the reporting person pursuant to § 232.101(b)(4) of this chapter.

(b) At the time this Form or any amendment is filed with the Commission, file one copy with each Exchange on which any class of securities of the issuer is registered. If the issuer has designated a single Exchange to receive Section 16 filings, the copy shall be filed with that Exchange only.

(c) Any person required to file this Form or amendment shall, not later than the time the Form or amendment is transmitted for filing with the Commission, send or deliver a copy to the person designated by the issuer to receive the copy or, if no person is so designated, the issuer's corporate secretary (or person performing similar functions) in accordance with Rule 16a-3(e).

3. Class of Securities Reported

(a) (i) Persons reporting pursuant to Section 16(a) of the Exchange Act shall report each transaction resulting in a change in beneficial ownership of any class of equity securities of the issuer and the beneficial ownership at the end of the month of that class of equity securities, even though one or more of such classes may not be registered pursuant to Section 12 of the Exchange Act.

(ii) Persons reporting pursuant to Section 17(a) of the Public Utility Holding Company Act of 1935 shall report each transaction resulting in a change in beneficial ownership of any class of securities (equity or debt) of the registered holding company and all of its subsidiary companies and the beneficial ownership at the end of the month of that class of securities. Specify the name of the parent or subsidiary issuing the securities.

(iii) Persons reporting pursuant to Section 30(f) of the Investment Company Act of 1940 shall report each transaction resulting in a change in beneficial ownership of any class of securities (equity or debt) of the registered closed-end investment company (other than “short-term paper” as defined in Section 2(a)(38) of the Investment Company Act) and the beneficial ownership at the end of the month of that class of securities.

(b) The title of the security should clearly identify the class, even if the issuer has only one class of securities outstanding; for example, “Common-Stock,” “Class A Common Stock,” “Class B Convertible Preferred Stock,” etc.

(c) The amount of securities beneficially owned should state the face amount of debt securities (U.S. Dollars) or the number of equity securities, whichever is appropriate.

4. Transactions and Holdings Required to be Reported

(a) General Requirements

(i) Report, in accordance with Rule 16a-3(g), all transactions not exempt from Section 16(b) of the Act and all exercises and conversions of derivative securities, regardless of whether exempt from Section 16(b) of the Act, resulting in a change of beneficial ownership in the issuer's securities. Every transaction shall be reported even though acquisitions and dispositions during the month are equal. Report total beneficial ownership as of the end of the month for each class of securities in which a transaction was reported. Note: The amount of securities beneficially owned at the end of the month specified in Column 5 of Table I and Column 9 of Table II should reflect those holdings reported or required to be reported by the date of the Form. Transactions and holdings eligible for deferred reporting on Form 5 need not be reflected in the month end total unless the transactions were reported earlier or are included on this Form.

(ii) Each transaction should be reported on a separate line. Transaction codes specified in Item 8 should be used to identify the nature of the transaction resulting in an acquisition or disposition of a security. Note: Transactions reportable on Form 5 may, at the option of the reporting person, be reported on a Form 4 filed before the due date of the Form 5. (See Instruction 8 for the code for voluntarily reported transactions.)

(b) Beneficial Ownership-Reported (Pecuniary Interest)

(i) Although for purposes of determining status as a ten percent holder, a person is deemed to beneficially own securities over which that person exercises voting or investment control (see Rule 16a-1(a)(1)), for reporting transactions and holdings, a person is deemed to be the beneficial owner of securities if that person has the opportunity, directly or indirectly, to profit or share in any profit derived from a transaction in the securities (“pecuniary interest”). See Rule 16a-1(a)(2). See also Rule, 16a-8 for the application of the beneficial ownership definition to trust holdings and transactions.

(ii) Both direct and indirect beneficial ownership of securities shall be reported. Securities beneficially owned directly are those held in the reporting person's name or in the name of a bank, broker or nominee or the account of the reporting person. In addition, securities held as joint tenants, tenants in common, tenants by the entirety, or as community property are to be reported as held directly. If a person has a pecuniary interest, by reason of any contract, understanding or relationship (including a family relationship or arrangement), in securities held in the name of another person, that person is an indirect beneficial owner of the securities. See Rule 16a-1(a)(2)(ii) for certain indirect beneficial ownerships.

(iii) Report transactions in securities beneficially owned directly on a separate line from those beneficially owned indirectly. Report different forms of indirect ownership on separate lines. The nature of indirect ownership shall be stated as specifically as possible; for example, “By Self as Trustee for X,” “By Spouse,” “By X Trust,” “By Y Corporation,” etc.

(iv) In stating the amount of securities acquired, disposed of, or beneficially owned indirectly through a partnership, corporation, trust, or other entity, report the number of securities representing the reporting person's proportionate interest in transactions conducted by that entity or holdings of that entity. Alternatively, at the option of the reporting person, the entire amount of the entity's interest may be reported. See Rule 16a-1(a)(2)(ii)(B) and Rule 16a-1(a)(2)(iii).

(v) Where more than one beneficial owner of the same equity securities must report transactions on Form 4, such owners may file Form 4 individually or jointly. Joint and group filings may be made by any designated beneficial owner. Transactions with respect to securities owned separately by any joint or group filer are permitted to be included in the joint filing. Indicate only the name and address of the designated filer in Item I of Form 4 and attach a listing of the names and IRS or social security numbers (or addresses in lieu thereof) of each other reporting person. Joint and group filings must include all required information for each beneficial owner, and such filings must be signed by each beneficial owner, or on behalf of such owner by an authorized person. If the space provided for signatures is insufficient, attach a signature page. Submit any attached listing of names or signatures on another Form 4, copy of Form 4 or separate page of 8½ by 11 inch white paper, indicate the number of pages comprising the report (Form plus attachments) at the bottom of each report page (e.g., 1 of 3, 2 of 3, 3 of 3), and include the name of the designated filer and information required by Items 2 and 4 of the Form on the attachment.

(c) Non-Derivative and Derivative Securities

(i) Report acquisitions or dispositions and holdings of non-derivative securities in Table I. Report acquisitions or dispositions and holdings of derivative securities (e.g., puts, calls, options, warrants, convertible securities, or other rights or obligations to buy or sell securities) in Table II. Report the exercise or conversion of a derivative security in Table II (as a disposition of the derivative security) and report in Table I the holdings of the underlying security. Report acquisitions or dispositions and holdings of derivative securities that are both equity securities and convertible or exchangeable for other equity securities (e.g., convertible preferred securities) only in Table II.

(ii) The title of a derivative security and the title of the equity security underlying the derivative security should be shown separately in the appropriate columns in Table II. The “puts” and “calls” reported in Table II include, in addition to separate puts and calls, any combination of the two, such as spreads and straddles. In reporting an option in Table II, state whether it represents a right to buy, a right to sell, an obligation to buy, or an obligation to sell the equity securities subject to the option.

(iii) Describe in the appropriate columns in Table II characteristics of derivative securities, including title, exercise or conversion price, date exercisable, expiration date, and the title and amount of securities underlying the derivative security. If the transaction reported is a purchase or a sale of a derivative security, the purchase or sale price of that derivative security shall be reported in column 8. If the transaction is the exercise or conversion of a derivative security, leave column 8 blank and report the exercise or conversion price of the derivative security in column 2.

(iv) Securities constituting components of a unit shall be reported separately on the applicable table (e.g., if a unit has a non-derivative security component and a derivative security component, the non-derivative security component shall be reported in Table I and the derivative security component shall be reported in Table II). The relationship between individual securities comprising the unit shall be indicated in the space provided for explanation of responses. When securities are purchased or sold as a unit, state the purchase or sale price per unit and other required information regarding the unit securities.

5. Price of Securities

(a) Prices of securities shall be reported in U.S. dollars on a per share basis, not an aggregate basis, except that the aggregate price of debt shall be stated. Amounts reported shall exclude brokerage commissions and other costs of execution.

(b) If consideration other than cash was paid for the security, describe the consideration, including the value of the consideration, in the space provided for explanation of responses.

6. Additional Information

If the space provided in the line items of this Form or space provided for additional comments is insufficient, attach another Form 4, copy of Form 4 or separate page of 8½ by 11 inch white paper to Form 4, completed as appropriate to include the additional comments. Each attached page must include information required in Items 1, 2 and 4 of the Form. The number of pages comprising the report (Form plus attachments) shall be indicated at the bottom of each report page (e.g., 1 of 3, 2 of 3, 3 of 3). If additional information is not reported in this manner, it will be assumed that no additional information was provided.

7. Signature

(a) If the Form is filed for an individual, it shall be signed by that person or specifically on behalf of the individual by a person authorized to sign for the individual. If signed on behalf of the individual by another person, the authority of such person to sign the Form shall be confirmed to the Commission in writing in an attachment to the Form or as soon as practicable in an amendment by the individual for whom the Form is filed, unless such a confirmation still in effect is on file with the Commission. The confirming statement need only indicate that the reporting person authorizes and designates the named person or persons to file the Form on the reporting person's behalf, and state the duration of the authorization.

(b) If the Form is filed for a corporation, partnership, trust, or other entity, the capacity in which the individual signed shall be set forth (e.g., John Smith, Secretary, on behalf of X Corporation).

8. Transaction Codes

Use the codes listed below to indicate in Table I, Column 3 and Table II, Column 4 the character of the transaction reported. Use the code that most appropriately describes the transaction. If the transaction is not specifically listed, use transaction Code “J” and describe the nature of the transaction in the space for explanation of responses. If a transaction is voluntarily reported earlier than required, place “V” in the appropriate column to so indicate; otherwise, the column should be left blank. If a transaction involves an equity swap or instrument with similar characteristics, use transaction code “K” in addition to the code(s) that most appropriately describes the transaction, e.g., “S/K” or “P/K.”

General Transaction Codes

P—Open market or private purchase of non-derivative or derivative security

S—Open market or private sale of non-derivative or derivative security

V—Transaction voluntarily reported earlier than required

Rule 16b-3 Transaction Codes

A—Grant, award or other acquisition pursuant to Rule 16b-3(d)

D—Disposition to the issuer of issuer equity securities pursuant to Rule 16b-3(e)

F—Payment of exercise price or tax liability by delivering or withholding securities incident to the receipt, exercise or vesting of a security issued in accordance with Rule 16b-3

I—Discretionary transaction in accordance with Rule 16b-3(f) resulting in acquisition or disposition of issuer securities

M—Exercise or conversion of derivative security exempted pursuant to Rule 16b-3

Derivative Securities Codes (Except for transactions exempted pursuant to Rule 16b-3)

C—Conversion of derivative security

E—Expiration of short derivative position

H—Expiration (or cancellation) of long derivative position with value received

O—Exercise of out-of-the-money derivative security

X—Exercise of in-the-money or at-the-money derivative security

Other Section 16(b) Exempt Transaction and Small Acquisition Codes (except for Rule 16b-3 codes above)

G—Bona fide gift

L—Small acquisition under Rule 16a-6

W—Acquisition or disposition by will or the laws of descent and distribution

Z—Deposit into or withdrawal from voting trust

Other Transaction Codes

J—Other acquisition or disposition (describe transaction)

K—Transaction in equity swap or instrument with similar characteristics

U—Disposition pursuant to a tender of shares in a change of control transaction

As can be seen, the information to be filed in Form 4 is quite complex, with the filing being made even more cumbersome when using the EDGAR system.

What is now presented is a simplified electronic reporting and filing system called the EDGAR Filing Wizard.

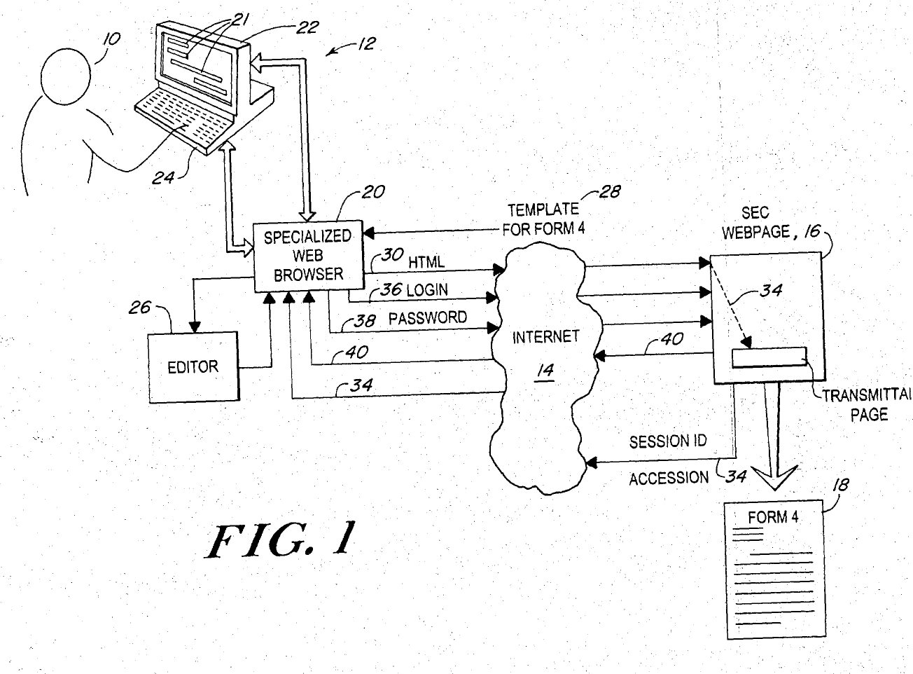

Referring now to FIG. 1, a method is described for an individual 10 to electronically file with the Securities and Exchange Commission a required form through the utilization of the individual's computer 12 and the internet 14 which couples computer 12 to the SEC website and more particularly to a web page 16 provided by the Securities and Exchange Commission.

In order to insure a timely filing of a form, here Form 4 as illustrated at 18, a specialized web browser 20 is utilized within computer 12 and is provided with a predetermined template 28 for the particular form involved. Here the template is for Form 4.

Upon accessing this specialized web browser, individual 10 enters the required information into fields 21 provided on display 22 of computer 12, with keyboard 24 provided for entering the required information the fields. Specialized web browser 20 has associated with it an editor 26 for editing the information in the fields, with the result being transmitted over the internet to web page 16.

All information entered into fields 21 of specialized web browser 20 is encoded in the appropriate format relative to template 28 and is transmitted via the HTTP protocol in HTML as illustrated at 30 to web page 16's URL.

It is an important part of the subject invention that regardless of what links are on web page 16, the URL for the transmittal page 32 of web page 16 is that which is addressed by the specialized web browser. Thus all links in the Securities and Exchange Commission web page are bypassed as illustrated by dotted line 34 such that the edited and finalized form is submitted directly to transmittal page 32. The result is the appropriate form 18, which is completed at the user's computer and has been properly formatted so that it can be accepted by the Securities and Exchange Commission. The acceptance is indicated by an Accession Number 34 transmitted back over the Internet and is presented to individual 10 on display 22 via email.

Thus the subject system operates solely through the utilization of the specialized web browser once the appropriate login 36 and password 38 have been entered into the appropriate fields in order to access the SEC website.

As will be seen, once the login and password have been transmitted to the SEC website, the website returns a Session ID on 40 which is transmitted to the specialized web browser so as to identify the user when the user finishes completing the particular form.

In operation, the mechanism by which one provides information into the appropriate format which is acceptable to EDGAR starts by the creation of a blank form that is already in the HTML format. The user then enters in information in the fields presented. The form is generated knowing where each piece of information is to go in the blank form such that the entry into a field places the information at the appropriate place. Note, any characters that the EDGAR system will not accept are not permitted. What is provided is a look-up table with the data entered in a character substitution operation. The wizard substitutes any characters as are needed, with the characters plugged into the blank form that was created before hand. All that is then done is save this as a file. Note that it is saved as an HTML file and is stored on the user's computer until it is transmitted.

With respect to the generation of the document carriage returns, half characters and certain symbols or even hyphens have to be done in a certain way. The wizard has preknowledge on how this is done by simply having been generated through understanding the rules that are published about the EDGAR system. These rules, as mentioned above, detail what will be accepted and the system provides a look-up table to replace those characters which do not conform to the EDGAR rules.

The storage process is a relatively standard and involves picking a file name and writing it to a disk, namely the user's hard drive. It is up to the user to name the file once the file has been completed at the user terminal.

It will be appreciated that the language utilized by the EDGAR system is a very specific format called XFDL which is related to HTML. One can view this language as being akin to an envelope. It contains some basic information such as who is doing the filing and the kind of file it is to be. This process is analogous to having an attachment with the actual HTML file.

Thus, the form is prepared according to all the rules that are laid out and in the above analogy this is like an envelope around the actual HTML file.

Once the file has been prepared, the user is asked for his login and password. Since the wizard already knows ahead of time where the file needs to go, e.g., what address or URL is it to be sent to, the completed properly-formatted file goes to this URL. The system then logs in with the user's name and password given by the SEC. The SEC then responds back with a Session ID number.

In operation, there are actually two places where the transmission from the user goes to. The first is the login URL and the second is to the URL of the transmittal page.

Prior to going to the transmittal page, the Session ID is transmitted back to the user's browser, with the user's browser storing the Session ID with the associated file. It is the purpose of the Session ID to identify, who the user is. It is like a credential, and it expires. In one embodimetn, it is only good for a one time log in.

After having obtained the Session ID number the specialized browser addresses the transmittal page URL. Part of that address includes the Session ID which is one of the parameters that is passed to the SEC. What the specialized browser does is to transmit the file to the transmittal page URL giving the transmittal page URL and the appropriate parameters so that the file can be uploaded by the SEC.

Once one has pressed the finished button, this means that the correct URL is addressed, the Session ID is transmitted and the data relating to the form is transmitted in HTML to the transmittal page.

It will be noted that if an Accession Number is transmitted via e-mail back to the user, it tells the user that the SEC has received the file.

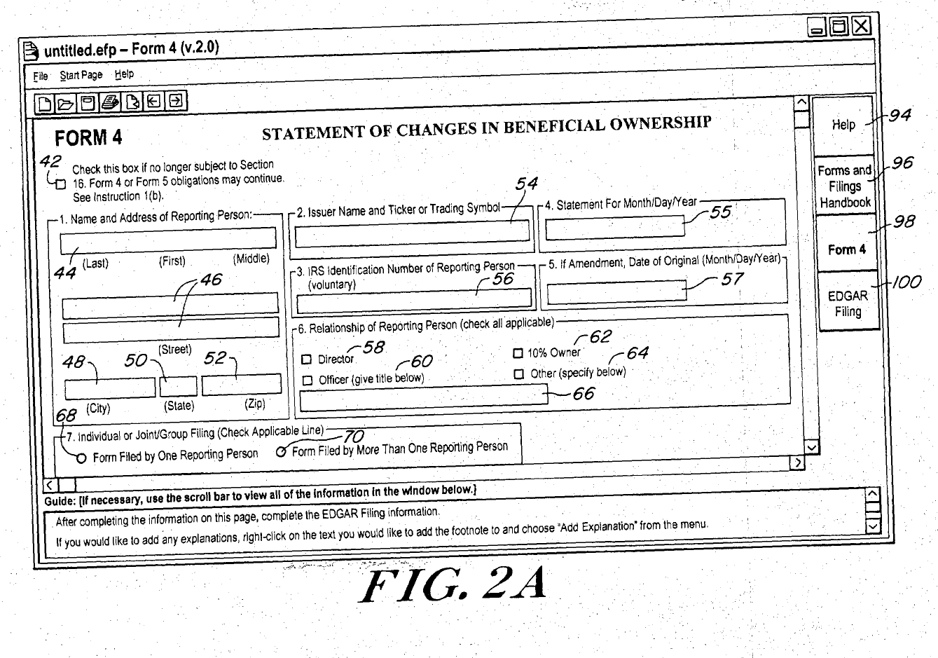

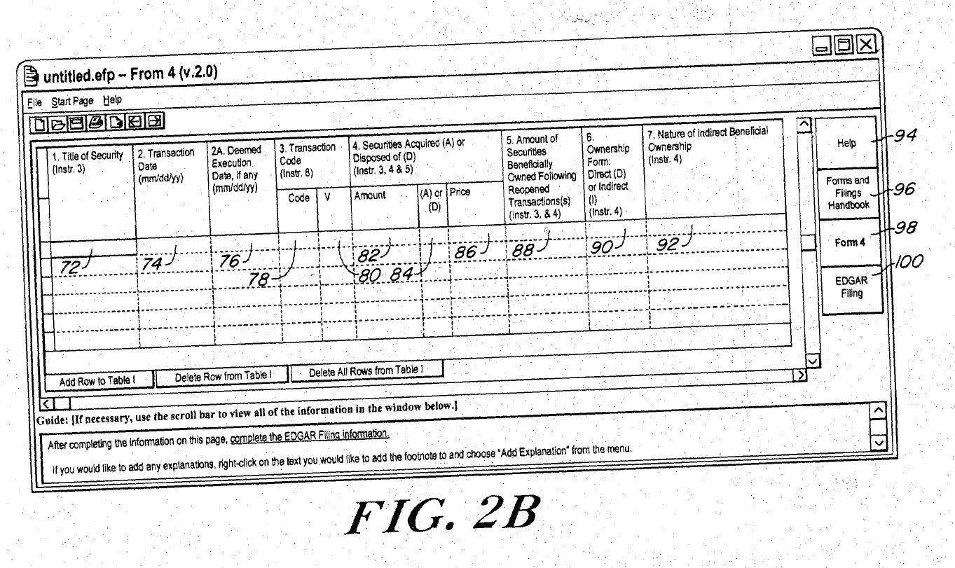

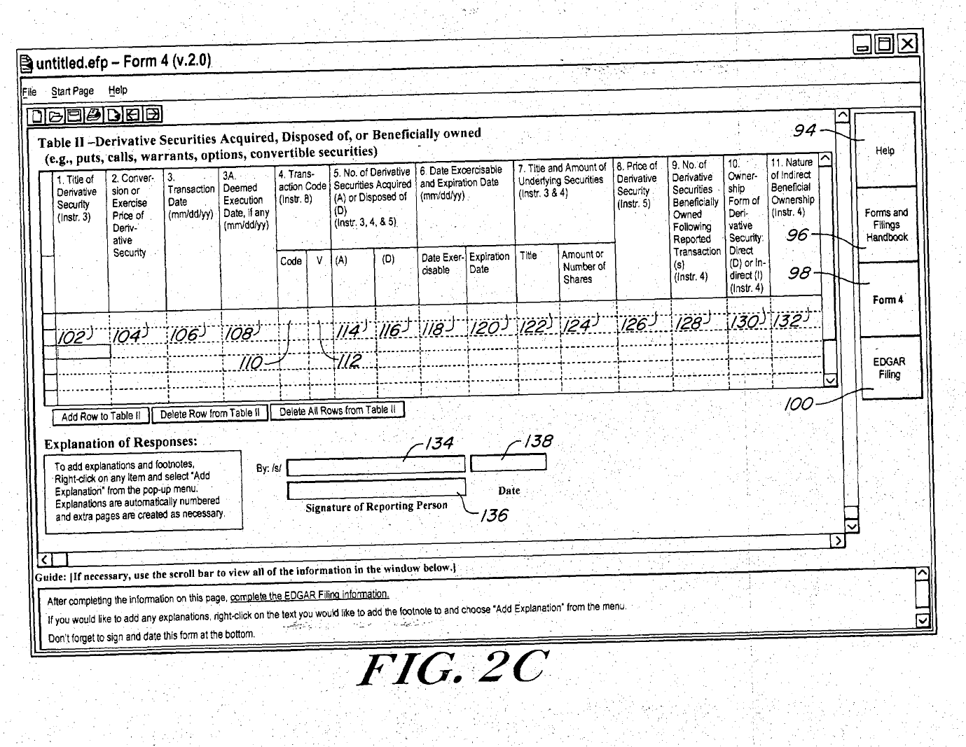

Referring now to FIGS. 2A-2C, what is shown are the screen shots presented to the individual 10 of FIG. 1 as the individual is completing, in this case Form 4. Here it can be seen that a box 42 is provided which needs to be checked if the individual is no longer subject to Section 16. Assuming the individual is subject to Section 16, then the individual indicates his name at field 44, his address at fields 46 and his city at field 48, along with his state at field 50 and his zip code at field 52. As illustrated at field 54 the issuer's name and ticketed tracking symbol is to be entered, followed by the IRS identification number of the reporting person at field 56 which is optional. Field 55 is used to enter the Statement Date, whereas field 57 is used to indicate, if the form is an amendment, the date of the original submission.

The relationship of the reporting person is indicated at box 58 for a director, box 60 for an officer, box 62 for a 10% owner, or box 64 for “other”, whereas a field 66 is provided for entry of further information. As illustrated by box 68 one indicates whether the form is being filed by one reporting person or at 70 whether the form is being filed by more than one reporting person.

Referring to FIG. 2B the type of security is entered at field 72, the transaction date at field 74, the deemed execution date at field 76, and the transaction code at fields 78 and 80, with the amount of the securities acquired or disposed of being entered into field 82. A field 84 indicates by (A) or (D) whether the security is either acquired or disposed of, whereas the price is entered into at field 86.

In field 88 is entered the amount of the securities beneficially owned following reported transactions, whereas in field 90 the ownership form direct or indirect code is entered, followed by field 92 which is the nature of any indirect beneficial ownership.

Note that on the screen there are buttons relating to “Help” as illustrated at 94 a “Forms and Filing” button 96, a “Form 4” button 98, and an EDGAR filing button 100.

Referring now to FIG. 2C for derivatives securities acquired, disposed of or beneficially owned, a field 102 is provided for the title of the derivative security. Field 104 is used for entering the conversion or exercise price of the derivative security, and field 106 is used for entry of the transaction date. Field 108 permits entry of the deemed execution date if any, whereas fields 110 and 112 are for entering transaction codes. Fields 114 and 116 are used to indicate the number of derivative securities acquired or disposed of, whereas fields 118 and 120 are for entering the date exercisable and expiration date respectively. Fields 122 and 124 are for entry of the title and the amount of the underlying securities, whereas field 126 is for entry of the price of the derivative security. Field 128 is for entry of the number of the derivative securities beneficially owned following the reported transaction, whereas field 130 is for entry of the ownership form of the derivative security, either direct or indirect. Finally in field 132 the nature of the indirect beneficial ownership is to be indicated.

A note at the bottom of this screen shot indicates that to add explanations and footnotes one right clicks on any item and selects “add explanation” from the popup menu. Explanations are automatically numbered and extra pages are created as necessary.

Finally a field is provided for the signature of the person filing the form at fields 134 and 136, whereas the date for the execution for the form is entered in field 138.

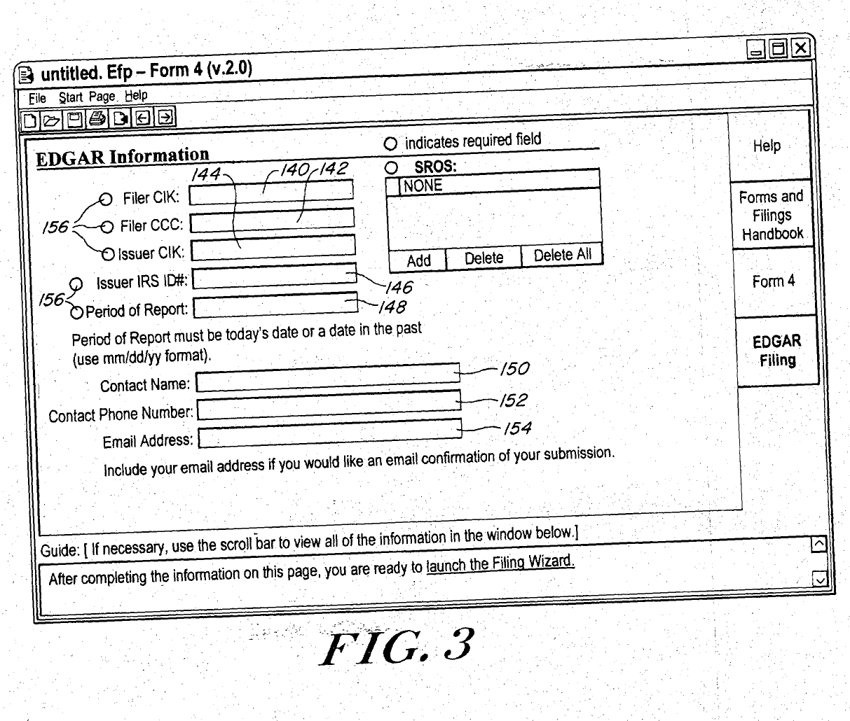

Prior to filing the form, as illustrated in FIG. 3 the individual must provide to the Securities and Exchange Commission the filer's CIK as illustrated at field 140, the filer's CCC at 142 the issuers CIK at 144 and the issuers IRS identification number as illustrated at field 146. Moreover, the period of the report is entered into field 148. The contact name is entered into field 150 and the contact's phone number at field 152, along with the contact's email address at field 154. Note darkened circles 156 indicate required fields to be filled in.

As can be seen from FIG. 4, this screen shot is provided after the subject method checks the form for errors to indicate whether the submission will be a live or test filing. Either a box 156 is checked for a test filing or box 158 is checked for a live filing, with button 160 indicating that the file is to be built and sent.

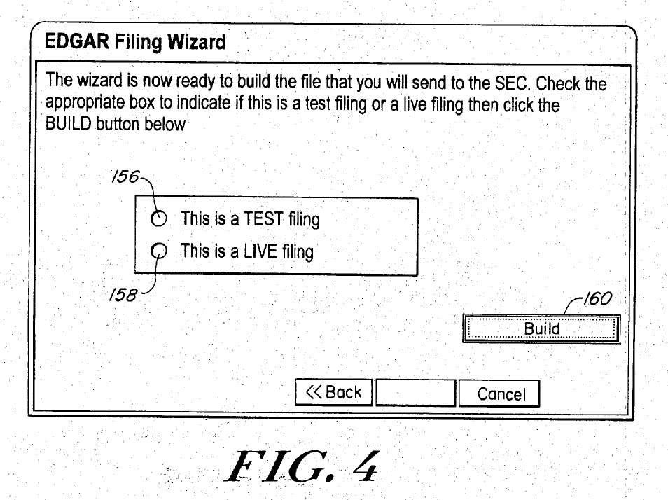

As illustrated in FIG. 5, the filing entity enters his or her CIK in field 160 and his or her password in 162, with button 164 being pressed when these fields have been appropriately completed.

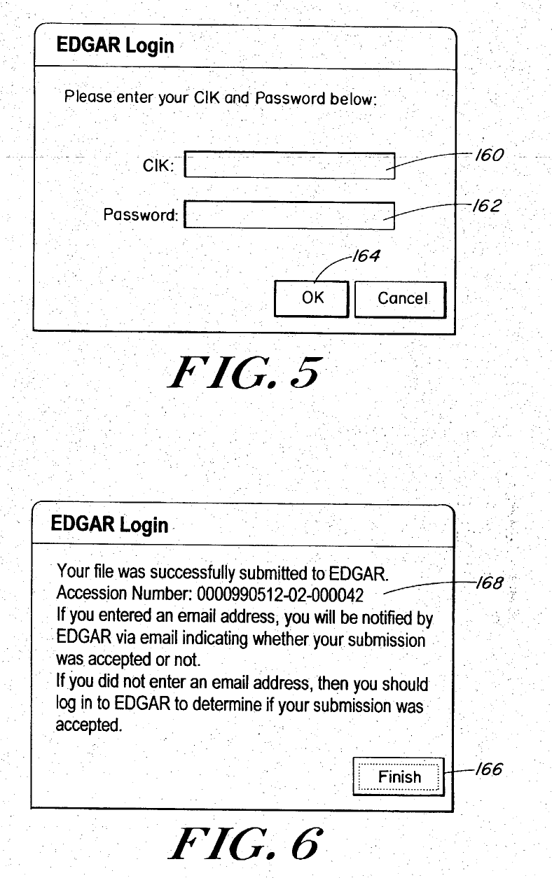

In order to file the form and as illustrated in FIG. 6, one pushes the “finish” button here illustrated 166, where if the submission is successful an Accession Number, here illustrated at 168, is displayed to the individual.

What can be seen is that filing of Form 4 is a relatively simple process in which all of the formatting is provided by the specialized web browser, which properly formats the information and transmits it in HTML. This is a language which is understood by the EDGAR system such that once the information is entered properly into the fields noted above, there will be no formatting errors involved in the transmission of the information. Moreover it is transmitted directly to the transmittal page of the SEC website bypassing all other links. No longer will there be any confusing links or confusing error message, with an acceptable form to be completed and transmitted not in days but in minutes.

What is now presented is a program listing for the subject invention:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A method for forwarding forms over the Internet in the appropriate format for acceptance, comprising the steps of:
providing a specialized web browser which has a template for the information needed to complete the form.
transmitting a form completed using the specialized web browser to a predetermined website address designed for receiving web-generated form submissions.

2. The method of claim 1, wherein the receiving website includes a number of links and wherein the browser used in transmitting a completed form bypasses all intervening links to transmit a completed form to the website address identified as the address to which a completed form is to be transmitted.

3. The method of claim 1, wherein the website is an EDGAR website.

4. The method of claim 1, wherein the language in which the form is transmitted is the language used by the receiving website.

5. The method of claim 4, wherein the language includes HTML.

6. A method for completing and filing Security and Exchange Commission forms using the multi-step from submission EDGAR system, comprising the steps of:
formulating a submission to the Security and Exchange Commission using a browser having a template and structure to force the submitted into a format acceptable to the EDGAR system; and,
transmitting the submission using the internet to an internet address at the Securities and Exchange Commission form submission website at which the final submission is to be routed, thus to eliminate intermediate steps imposed by the EDGAR system.

7. The method of claim 6, wherein the formulating and transmission steps include the use of a specialized web browser.

8. The method of claim 7, wherein the specialized web browser utilizes a predetermined template.

9. The method of claim 6, wherein the language in which the submission is transmitted is a language understood by the EDGAR system.

10. The method of claim 9, wherein the language includes HTML.

11. A system for transmitting forms to the Security and Exchange Commission via a website maintained by the Security and Exchange Commission, comprising:
a computer terminal connected to the internet including data entry means for completing a form;
a specialized browser operating on said terminal and having a display of the form to be completed that includes fields to be filled in by the user of said terminal, and addressing a URL at the Securities and Exchange Commission website, said browser having a template corresponding to the form to be transmitted and operating to formulate the information entered into said form in a language and said template accetable to the reporting system used by the Securities and Exchange Commission; and,
means within said specialized browser for addressing that predetermined website address on the website of the Securities and Exchange Commission which is to receive a final form submission, thus to bypass any other links of said website, and for transmitting the completed form.

12. The system of claim 11, wherein the reporting system used by the Securities and Exchange Commission includes the EDGAR system.

13. The system of claim 11, wherin said form is Form 4.

14. The system of claim 11, wherein one field on said specialized browser is the e-mail address of the user of said terminal and further including an e-mail client at the Securities and Exchange Commission for e-mailing said terminal upon acceptance of a submittal form.

15. The system of claim 11, wherein said specialized browser provides a user password and login and wherein upon receipt of said password and login by the Securities and Exchange Commission an accession number is transmitted to said terminal to identify the user of said terminal.
